(19) United States
(12) Patent Application Publication
(10) Pub. No.: US 2005/0168667 A1
(43) Pub. Date: Aug. 4, 2005

(54) Liquid crystal display and fabricating the same

(75) Inventors: Kiyohiro Kawasaki, Osaka (JP); Ching-Lung Chiang, Tao Yuan Shien (TW)

Correspondence Address: BACON & THOMAS, PLLC, 625 SLATERS LANE, FOURTH FLOOR, ALEXANDRIA, VA, 22314, US

(73) Assignee: Quanta Display Inc., Osaka (JP)

(21) Appl. No.: 11/043,948

(22) Filed: Jan. 28, 2005

(30) Foreign Application Priority Data
Jan. 29, 2004 (JP) JP2004-021292

(51) Int. Cl. G02F 1/136

(52) U.S. Cl. 349/43

(57) ABSTRACT

In the 5-mask and 4-mask processes, during the formation of contacts, breakings in the pixel electrodes and unstable contacts that follow tend to occur. Using source-drain wires consisting of a lamination layer of a heat resistant metal layer and an aluminum layer, the undercuts of the passivation insulating layer formed by removing an aluminum layer in the openings on drain electrodes is resolved by adding manufacturing processes to enlarge the said openings.

### BACKGROUND OF THE INVENTION

1. Field of the Invention

This invention is related to a liquid crystal display device that has a color image display function, especially to an active type liquid crystal display device.

2. Description of Related Art

With the advancement of fine processing technology, liquid crystal material technology, high density mounting technology, etc. in recent years, a large quantity of televisions and other image display devices are now commercially available with liquid crystal display devices of 5-50 cms in diagonal dimension. In addition, color display has been realized easily by forming an RGB colored layer on one of the 2 glass substrates composing a liquid crystal panel. The active-type liquid crystal panels that have switching elements in each pixel, especially, are able to provide images with less cross talk, quick response speed, and high contrast ratio.

These liquid crystal display devices (liquid crystal panels) usually have matrix formation of approximately 200-1,200 scanning lines and 300-1,600 signal lines, but larger screens and higher precision are being offered simultaneously nowadays in order to meet the increase of display capacity.

FIG. 5 shows how the liquid crystal device is mounted onto a liquid crystal panel. The methods to provide electric signals to the image display area include the following: 1) The method to connect a semiconductor integrated circuit chip 3 that provides driving signals to electrode terminals 5 of scanning lines formed on one of the transparent insulating substrates composing the liquid crystal 1, a glass substrate 2 for example, with a conductive adhesive agent. 2) The TCP (Tape-Carrier-Package) method to pressure-weld the TCP film 4, which has terminals of gold or solder-plated copper foils on a thin polyimide resin film base for example, to electrode terminals of signal lines 6, using an appropriate adhesive agent that includes a conductive medium. Both methods are shown here for convenience, but the most appropriate method between the two is selected in actual cases.

The wiring paths 7 and 8, which connect the pixels within the image display area located in the center area of the liquid crystal panel 1 and electrode terminals for scanning lines and signal lines 5 and 6, do not need to be composed of the same conductive material as electrodes 5 and 6.

FIG. 6 shows an equivalent circuit of an active liquid crystal display device, which distributes insulating gate type transistors 10 in each pixel as a switching element, 11 (7 in FIG. 5) means the scanning lines, 12 (8 in FIG. 5) means the signal lines, and 13 means liquid crystal cells, and the liquid crystal cells 13 are treated as capacitors for electricity. Elements drawn in solid lines are formed on glass substrate 2, one of the two substrates to compose a liquid crystal panel, and the counter electrode 14, which is shared among the liquid crystal cells 13, drawn with a dotted line, is formed on the principal plane that faces the other glass substrate 9. In case the off resistance of the insulating gate type transistor 10 or liquid resistance of the liquid crystal cell 13 is low or the graduation of the display images is emphasized, a circuit mean such as supplementary storage capacitances 15 is added to the liquid crystal cell 13 in order to increase the time constant of the liquid cell 13 as a load. In addition, 16 means a storage capacitance line which is the common bus bar for the storage capacitance 15.

FIG. 7 shows the cross section of the main part of image display area for a liquid crystal display device. The two glass substrates, 2 and 9, which compose a liquid crystal panel 1 are formed at a specific distance such as a few gm, according to the spacer material (not shown) such as plastic fiber, plastic beads, or pillar-shaped spacers formed on color filter 9, and the gap is a closed space encapsulated by a sealing material and encapsulating material consisting of organic resin at the periphery of the glass substrate 9. Liquid crystal 17 is filled in this closed space.

To obtain color display, a thin organic film of 1-2 μm in thickness, or colored layer 18, including a dye and/or pigment on the closed space side of the glass substrate 9 gives the color display function; in such a case, the glass substrate 9 is called the color filter (CF). Depending on the property of the liquid crystal material 17, a polarizing plate 19 is attached to the upper surface of the glass substrate 9 and/or lower surface of the glass substrate 2, and the liquid crystal panel 1 functions as an electro-optical device. Today, most of the commercially available liquid crystal display panels use a TN (Twisted Nematic)-type liquid crystal material, normally requiring 2 polarizing plates 19. Transmissive liquid crystal panels, though not shown here, use rear lighting as a light source, radiating white light up from a lower position.

The polyimide based thin resin film 20 of approximately 0.1 μm in thickness for example, which is formed on two glass substrates 2 and 9 after being exposed to liquid crystal 17, is a film that orientates liquid crystal molecules into specific directions. 21 is a drain electrode (wire) that connects a drain of the insulating gate type transistor 10 and pixel electrode 22 of transparent conductivity, normally formed at the same time as the signal (source) line 12. A semiconductor layer 23 is found between the signal line 12 and drain electrode 21 and is explained later in detail. The Cr thin film layer 24 of about 0.1 μm in thickness, which is formed in the border area of the adjacent colored layer 18 on the color filter 9, is a light shielding component that prevents outside light from coming into the semiconductor layer 23, scanning lines 11, and signal lines 12; this established technology is commonly known as black matrix (BM).

Here, the structure and the manufacturing method of insulating gate type transistor as a switching element are explained. Two kinds of insulating gate type transistors are frequently used today, but one of the two types, the etch-stop type, is introduced here as the conventional example. FIG. 8 shows the plan view for a unit pixel of the active substrate (a semiconductor device for a display device) that composes a conventional liquid crystal panel. The manufacturing process is briefly explained below by showing the cross section of FIG. 8(e) at lines A-A′, B-B′, and C-C′ in FIG. 9.

First, as shown in FIGS. 8(a) and 9(a), a primary metal layer of approximately 0.1-0.3 μm in film thickness is deposited on the principal plane of a glass substrate 2 of 0.5-1.1 mm in thickness, such as Corning's product number 1737 as an example of a substrate with high heat-resistance, chemical-resistance, and transparency, using a vacuum film-deposing equipment such as an SPT (sputter) and selectively forming scanning lines 11 which also work as gate electrodes 11A and storage capacity lines 16, using fine processing technology such as photosensitive resin patterns. The material for scanning lines is selected after considering the all-round heat-resistance, chemical-resistance, and conductivity, but a high heat-resistance metal such as Cr, Ta, and Mo or an alloy thereof such as MoW is usually used.

It is reasonable to use AL (aluminum) as a material for scanning lines for lowering the resistance value of the scanning line value in response to larger screens and higher definition of liquid crystal panels, but the general technologies used today are lamination with the said heat resistant metals such as Cr, Ta, Mo, or their silicides and addition of an oxidized layer (Al203) onto the AL surface, using anode-oxidization, for AL alone has low heat-resistance. In other words, scanning lines 11 consist of 1 or more metal layers.

Next, deposit 3 kinds of thin film layers using a PCVD (plasma CVD) device, in the following order, a primary SiNx (silicon nitride) layer composing a gate insulating layer, a primary amorphous silicon (a-Si) layer 31 including almost no impurities and composing a channel for insulating gate type transistors, and a secondary SiNx layer 32 composing the insulating layer to protect a channel, over the entire surface of the glass substrate 2 with 0.3, 0.05, and 0.1 μm in thickness respectively, for example. As shown in FIGS. 8(b) and 9(b), selectively leave the secondary SiNx layers above the gate electrodes 11A narrower than the gate electrodes 11A, making them protective insulating layers 32D, and expose the primary amorphous silicon layer 31.

Continuingly, after depositing a secondary amorphous silicon layer 33, including an impurity such as phosphor, over the entire surface with 0.05 μm in thickness for example, also using the PCVD equipment, deposit in the following order 1) a thin film layer 34 as a heat-resistant metal layer of about 0.1 μm in thickness, such as Ti, Cr, Mo, etc., 2) an AL thin film layer 35 of about 0.3 μm in thickness as a low resistance wire layer, and 3) a Ti thin film layer 36 as an intermediate conductive layer of about 0.1 μm in thickness, using a vacuum film-producing equipment such as the SPT. Using fine processing technology such as photosensitive resin patterns, selectively form drain wires 21 and signal lines 12, which also work as drain electrodes and source electrodes for insulating gate type transistors, respectively, consisting of a lamination layer of 3 thin film layers, 34A, 35A, and 36A, which are source-drain wire materials as shown in FIGS. 8(c) and 9(c). This selective pattern formation is done through 1) etching Ti thin film layer 36, AL thin film layer 35, and Ti thin film layer 34 in this order, using the photosensitive resin patterns, as used in the formation of source-drain wires, as masks, then 2) removing the secondary amorphous silicon layer 33 between the source electrodes 12 and the drain electrodes 21 exposing the gate insulating layer 30, and also 3) removing the primary amorphous silicon layer 31 exposing the gate insulating layer 30 in other areas. This method is called the etch-stop method, for the etching of the secondary amorphous silicon layer 33 is automatically completed because the secondary SiNx or 32D (protective insulating layer, etch-stop layer, or channel protective layer) exists.

Source-drain electrodes 12 and 21 are formed partly (a few μms) overlapped on a flat surface with protective insulating layers 32D so that the insulating gate type transistors do not form offset structures. This overlapping is better when small, for it works electrically as parasitic capacitance. However, its practical value is only about 2 μms for it is determined by the accuracy of mask aligners (exposure equipments) and photomasks, the expansion coefficient of glass substrates, and the temperature of glass substrates during exposure.

Furthermore, after removing the said photosensitive resin patterns, 1) deposit an SiNx layer of approximately 0.3 μm in thickness on the entire surface of the glass substrate 2 as a transparent insulating layer as same as for a gate insulating layer using a PCVD equipment, making this a passivation insulating layer 37, 2) form openings 62 on the drain electrodes 21 and another openings 63, and 64 on the areas where electrode terminals of scanning lines 11 and signal lines 12 to be formed outside an image display area, using fine processing technology as shown in FIGS. 8(d) and 9(d), 3) remove the passivation insulating layer 37 and gate insulating layer 30 within the openings 63, exposing part 5 of scanning lines, within the openings 63, 4) remove the passivation insulating layer 37 within openings 62 and 64, exposing part of the drain electrodes 21 and part 6 of the signal lines, and 5) form openings 65 on the (electrode pattern parallel-bundling) storage capacitance lines 16, exposing part of the storage capacitance lines 16.

Lastly, complete this process by 1) deposing a transparent conductive layer of about 0.1-0.2 μm in thickness, such as ITO (Indium-Tin-Oxide) or IZO (Indium-Zinc-Oxide), using a vacuum film-depositing equipment such as the SPT, 2) selectively forming pixel electrodes 22 on the passivation insulating layer 37 containing the openings 62, using fine processing technology such as photosensitive resin patterns as shown in FIGS. 8(e) ad 9(e), making this an active substrate 2. Part of the exposed scanning lines 11 within the opening 63 and part of the signal lines 12 within the openings 64 may compose electrode terminals 5 and 6, respectively, and electrode terminals 5A and 6A consisting of ITO may be selectively formed on the passivation insulating layer 37, containing the openings 63 and 64 as shown in the figures. However, a short circuit wire 40, which connects the electrode terminals 5A and 6A, is usually formed at the same time, for resistance increased by forming stripes between the electrodes 5A/6A and short circuit wire 40 may be used as the high resistance needed for measures against static electricity (not shown in figures). Although not given parts number, but electrode terminals for the storage capacity lines 16 are formed containing the openings 65.

The low resistance wire layer 35 consisting of AL is not absolutely necessary if the wire resistance of the signal line 12 is not a problem. In such a case, simplification is possible by making a single layer of source-drain wires 12 and 21 if a heat resistant metal material such as Cr, Ta, and MoW is selected. As described above, it is important to secure an electric contact between the source-drain wires and the secondary amorphous silicon layer through a heat resistant metal layer; see the prior example in the Japanese Unexamined Patent Application Publication, the Heisei 7-74368 issue, for a detailed description of heat-resistance in the insulating gate type transistor. Furthermore, FIG. 8(c) shows that the storage capacitance 15 is formed in the area 50 (a diagonal line going up to the right hand side), where the storage capacity line 16 and the drain electrode 21 are overlapped at the level on both sides of the gate insulating layer 30, but its detailed description is not given here.

Japanese Unexamined Patent Application Publication Hei7-74368. The 5-piece-mask process mentioned above is not described in detail here, but this has been obtained as a result of streamlining the island-forming process for the semiconductor layer and contact-formation process; 7-8 photomasks used to be required before, but only 5 of them are required nowadays through the introduction of dry etching technology, largely contributing to cost reduction. In order to reduce the production cost of liquid display devices, it would be necessary to reduce the process cost of active substrates during the manufacturing process and to reduce the components cost during the panel assembly process and module mounting process as we all know. There are two ways to reduce the process cost; process reduction to reduce the process steps and the development of cheaper process or change to cheaper process. However, the 4-piece-mask process in which active substrates are obtained with 4 photomasks is described here as an example of process reduction. This 4-piece-mask process helps to reduce the photo-etching process by introducing halftone technology, and FIG. 10 shows the plan view for a unit pixel of an active substrate that correspond to the 4-piece-mask process. FIG. 11 shows the cross section at A-A′, B-B′, and C-C′ lines of FIG. 10(e). As already mentioned above, two kinds of insulating gate type transistors are frequently used, but the insulating gate type transistors of the channel etching type are used here.

First, deposit a primary metal layer about 0.1-0.3 μm in thickness over the principal plane of the glass substrate 2, as in the 5-piece-mask process, using a vacuum film-depositing equipment such as the SPT, and selectively form scanning lines 11 that also work as the gate electrodes 11A and storage capacity lines 16, using fine processing technology as shown in FIGS. 10(a) and 11(a).

Next, deposit the 3 kinds of thin film layers in the following order over the entire surface of the glass substrate 2, using the PCVD equipment: 1) an SiNx layer 30 composing the gate insulating layer, 2) a primary amorphous silicon layer 31 including almost no impurities and composing a channel for insulating gate type transistors, and 3) a secondary amorphous silicon layer 33 including impurities and composing the source-drains for insulating gate type transistors with such as about 0.3, 0.2, and 0.05 μm in thickness, respectively. Continuingly, deposition of the source-drain wire materials follows; using a vacuum film-depositing equipment such as the SPT, 1) deposit a) a Ti thin film layer 34 of 0.1 μm in thickness for a heat-resistant metal layer for example, b) an AL thin film layer 35 of 0.3 μm in thickness for a low resistance wire layer for example, and c) a Ti thin film layer 36 of 0.1 μm in thickness for an intermediate conductive layer for example and 2) selectively form drain wires 21 and signal lines 12 composing drain electrodes and source electrodes for the insulating gate type transistors, respectively, both overlapping partly with gate electrodes 11A, using fine processing technology. However, in this selective pattern formation, one of the most notable feature of streamlined 4-piece-mask process is that it forms photosensitive resin patterns 80A and 80B, whose thickness in the channel-formation area 80B between the source-drain (diagonal line) is 1.5 μm for example, and which are thinner than 3 μm, the thickness of the film in 80A (12) and 80A (21) in the source-drain wire-forming areas, respectively as shown in FIGS. 10(b) and 11(b) by using the halftone exposure technology.

As positive photosensitive resin is normally used for these photosensitive resin patterns 80A and 80B during the manufacture of substrates for liquid crystal display devices, the source-drain wire-forming area 80A is black, meaning that Cr thin film is formed, the channel area 80B is gray meaning that line-and-space Cr patterns of 0.5-1.5 μms in width are formed for example, and other areas are white, meaning that photomasks with removed Cr thin film may be used. Line and space is not resolved since the resolution of an exposure equipment is low in the gray area, and about half of the photomask light from the lamp light source may be transmitted, making it possible to obtain photosensitive resin patterns 80A and 80B, which have a cross section as shown in FIG. 11(b) according to the remaining film property of positive photosensitive resin. In addition, by forming a thin film, in the gray area, such as MoSi2 with different thickness from Cr thin film and not the Cr thin film slit, photomasks with equivalent functions may be obtained.

Etch Ti thin film layer 36, AL thin film layer 35, Ti thin film layer 34, secondary amorphous silicon layer 33, and primary amorphous silicon layer 31 in this order, using the said photosensitive resin patterns 80A and 80B as masks to expose the gate insulating layer 30 as shown in FIG. 11(b). If the film of the photosensitive resin patterns 80A and 80B is reduced by more than 1.5 μm using a method such as the oxygen plasma ashing method as shown in FIGS. 10(c) and 11(c), the photosensitive pattern 80B disappears and the channel area is exposed, enabling 80C (12) and 80C (21) to be left as they are only at the source-drain wire-forming area. Now etch again the Ti thin film layer, AL thin film layer, Ti thin film layer, secondary amorphous silicon layer 33A, and primary amorphous silicon layer 31 A by using the photosensitive resin patterns 80C(12) and 80C(21), whose film has been reduced in thickness, as masks. But etch the primary amorphous silicon layer 31A, leaving approximately 0.05-0.1 μm. For the source-drain wires are formed by etching the primary amorphous silicon layer 31A leaving approximately 0.05-0.1 μm after etching the metal layer, the insulating gate type transistors manufactured in this method are called channel-etched. Furthermore, for the resist pattern 80A is converted to 80C after its film is thinned down in the said plasma treatment, it is desirable to strengthen anisotropy in order to regulate the pattern dimension changes; oxygen plasma treatment by the RIE (Reactive Ion Etching) method is desirable, and ICP (Inductive Coupled Plasma) method or TCP (Transfer Coupled Plasma) method, which has plasma source of higher density, is even more desirable.

Next, after removing the said photosensitive resin patterns 80C(12) and 80C(21), as shown in FIGS. 10(d) and 11(d), process the following as same as for the 5-piece-mask process: 1) make a passivation insulating layer 37 by deposing an SiNx layer of approximately 0.3 μm in thickness, as a transparent insulating layer, on the entire surface of the glass substrate 2, 2) form openings 62, 63, and 64 in the electrode terminal-forming areas on the drain electrodes 21, scanning lines 11, and signal lines 12, 3) remove the passivation insulating layer 37 and gate insulating layer 30 within the openings 63 to expose part 5 of scanning lines 11 and also remove the passivation insulating layer 37 within the openings 62, 64 to expose part of drain wires 21 and part 6 of signal lines, and 4) similarly form openings 65 on the storage capacitor lines 16 and expose parts thereof.

Lastly, 1) deposit a transparent conductive layer of approximately 0.1-0.2 μm in thickness, such as ITO or IZO, using a vacuum film-depositing equipment such as the SPT and 2) complete forming an active substrate 2 by selectively forming transparent conductive pixel electrodes 22, containing the openings 62 on the passivation insulating layer 37, using fine processing technology as shown in FIGS. 10(e) and 11(e). As for the electrode terminals, transparent conductive electrode terminals 5A and 6A are formed from ITO on the passivation insulating layer 37 here, containing the openings 63 and 64.

Therefore, it is desirable to provide an improved speech recognition method to mitigate and/or obviate the aforementioned problems.

### SUMMARY OF THE INVENTION

As the contact formation process for drain electrodes 21 and scanning lines 11 is done simultaneously in the 5-piece-mask and 4-piece-mask process as described above, the insulating layers for the corresponding openings 62 and 63 differ in thickness and type. The passivation insulating layer 37 has a lower film-depositing temperature and film of inferior quality, compared with the gate insulating layer 30, resulting in making a 1-digit difference in the etching speed by fluorinated acid-based etching solution at several 1000 Å/minute and several 100 Å/minute, respectively; as excessive etching occurs on the upper part of the cross section at the openings 62 on the drain electrodes 21, not allowing to regulate the hole diameters, it uses the fluorinated gas-based dry etching method.

Because the opening 62 on drain electrodes 21 consist of only a passivation insulating layer 37, even if the dry etching method is used, making it impossible to avoid excessive etching, compared with openings 63 on scanning lines 11; as a result, film of the drain electrodes 21 (intermediate conductive layer 36A) may get thinner due to the etching gas, depending on the material used for the layer. Furthermore, when removing the photosensitive resin patterns after dry etching, it is usually processed by 1) eliminating approximately 0.1-0.3 μm of the photosensitive resin pattern surface by oxygen plasma ashing in order to remove polymers from the fluorinated surface, followed by 2) applying chemical treatment, using organic stripping solution such as Tokyo Ohka Kogyo's stripping solution 106, for example. However, when the film of intermediate conductive layer 36A gets thinner, exposing the ground material aluminum layer 35A, an insulator AL203 is formed on the surface of the aluminum layer 35A with oxygen plasma ashing treatment, making it difficult to obtain good ohmic contact with pixel electrodes 22. Thus, there is an attempt to avoid this problem by setting up the film 0.2 μm thicker in order to allow the reduced film thickness of the intermediate conductive layer 36A. Another way to avoid this problem is to remove the aluminum layer 35A, expose the ground material heat resistant metal layer or the thin film layer 34A, and form the pixel electrodes 22 when forming openings 62-65; in this case, there is a merit of not having to have an intermediate conductive layer 36A from the beginning.

However, as the said measures do not always work as effectively as expected if the thin film's homogeneity within the surface thickness is not good; the result is the same when the etching speed's homogeneity within the surface is not good. The second measure above does not require the intermediate conductive layer 36A, but the removing process of the aluminum layer 35A needs to be added, and there was a possibility of pixel electrodes 22 being cut off when the cross-section control operation for openings 62 is not appropriate.

The invention has taken this situation into consideration; and aim of this invention is not only securing the connection between the drain electrodes 21 and pixel electrodes 22 by simplifying the cross section control of the openings 62 but also simplifying the device by composing the signal lines 12 with 2 layers: a heat resistant metal layer and an aluminum layer and lowering the manufacturing cost of active substrates.

The openings 62 in this invention has been enlarged by executing additional etching of a passivation insulating layer within the openings 62 in order to get the cross section control of the said openings 62, and as a result, the problem of undercuts in the bottom part of the openings 62 caused by side etching of aluminum layers may be solved.

A liquid crystal display device with the insulating gate transistors, as described in Claim 1, has at least the following characteristics in a liquid crystal display device that is filled with liquid crystals between 1) a primary transparent insulating substrate that aligns, in a 2-dimensional matrix on a principal plane, unit pixels that have a) insulating gate type transistors, b) scanning lines that also work as gate electrodes and signal lines that also work as source wires for the said insulated transistors, and c) pixel electrodes that are connected to drain wires and 2) a secondary transparent insulating substrate or a color filter that faces the said primary transparent insulating substrate, I) Forming 1) scanning lines, 2) insulating gate type transistors, and 3) signal lines consisting of a lamination layer of a heat resistant metal layer and an aluminum layer, on a principal plane of a primary transparent insulating substrate, II) Forming an inorganic passivation insulating layer which has openings at least on the drain wires, on the said primary transparent insulating substrate, III) Slightly exposing the aluminum layers at the peripheries of the bottoms of the said openings and exposing the heat resistant metal layers for the most part, and IV) Forming pixel electrodes on the inorganic passivation insulating layer in the pixel electrode-forming areas to contain the openings on the said drain wires.

With this construction, as aluminum layers exist around the bottoms of the cross sections of openings on the drain electrodes, which are formed in the inorganic passivation insulating layer on active substrates, and also heat resistant metal layers exist below the said aluminum layers, step-like levels are formed in these openings downward from outside to inside. As a result, no breakings ever occur in the pixel electrodes formed on the inorganic passivation insulating layer containing the said openings.

Likewise, the liquid crystal display device described in Claim 5 also has the following characteristics: I) Forming 1) scanning lines, 2) insulating gate type transistors, and 3) signal lines consisting of a lamination layer of a heat resistant metal layer and an aluminum layer, on a principal plane of a primary transparent insulating substrate, II) Forming a passivation insulating layer which has openings at least on the drain wires and whose upper layer part is a photosensitive organic insulating layer, on the said primary transparent insulating substrate, III) Slightly exposing the aluminum layers at the peripheries of the bottoms of the said openings and exposing the heat resistant metal layers for the most part, and IV) Forming pixel electrodes on the said organic passivation insulating layer in the pixel electrode-forming areas to contain the openings on the said drain wires.

With this construction, as aluminum layers exist around the bottoms of the cross sections of openings on the drain electrodes, which are formed in the passivation insulating layer whose upper layer part is a photosensitive organic insulating layer on active substrates, and also heat resistant metal layers exist below the said aluminum layers, step-like levels are formed in these openings downward from outside to inside. As a result, no breakings ever occur in the pixel electrodes formed on the said organic passivation insulating layer containing the said openings.

The manufacturing method of the liquid crystal display device in Claim 10 is described in Claim 1 and is characterized by the following: I) The process for forming scanning lines, insulating gate type transistors, and signal lines consisting of a lamination layer of a heat resistant metal layer and an aluminum layer, II) The process for forming an inorganic passivation insulating layer which has openings at least on the drain wires, on the said primary transparent insulating substrate, III) The process for removing the aluminum layers that are exposed in the said openings, IV) The process for enlarging the said openings, and V) The process for forming pixel electrodes to contain the said enlarged openings after depositing a conductive layer.

With this construction, the undercut problem of the inorganic passivation insulating layer occurred at the bottoms of the openings which are formed on the drain wires, disappears, and the formed pixel electrodes containing the enlarged openings shall have no breakings.

The manufacturing method of the liquid crystal display device in Claim 15 is described in Claim 5 and is characterized by the following: I) The process for forming scanning lines, insulating gate type transistors, and signal lines consisting of a lamination layer of a heat resistant metal layer and an aluminum layer, II) The process for forming a passivation insulating layer which has openings at least on the drain wires and whose upper layer part is a photosensitive organic insulating layer, on the said primary transparent insulating substrate, III) The process for removing the aluminum layers that are exposed in the said openings, IV) The process for reducing the film thickness of the said organic passivation insulating layer to enlarge the said openings, and V) The process for forming pixel electrodes to contain the said enlarged openings, after depositing a conductive layer.

With this construction, the undercut problem of the passivation insulating layer whose upper layer part is a photosensitive organic insulating layer occurred at the bottoms of the openings which are formed on the drain-wires, disappears, and the formed pixel electrodes containing the enlarged openings shall have no breakings

As described above, this invention uses the technology resolving the undercut problem of a passivation insulating layer as a core, which is caused by removing the aluminum layer within the openings formed in the passivation insulating layer on the drain electrodes, with enlarging such openings to suggest a variety of substrates based on this construction.

Furthermore, as part of the liquid crystal display device described in this invention uses a photosensitive organic insulating layer for a passivation insulating layer, it may provide additional merits such as higher aperture ratio or easier handling of orientation-process with increasing the film thickness of the photosensitive organic insulating layer.

In addition, as the source-drain wires consist of a lamination layer of a heat-resistant metal layer and an aluminum layer, lowering of signal line resistance as well as costs due to their more simplified structure compared with conventional 3-layered structure including the intermediate insulating layer.

As described above, in forming openings in the passivation layer on drain electrodes consisting of a lamination layer of a heat resistant metal layer and an aluminum layer, the important element of this invention is that the undercut problem of the passivation insulating layer caused by removing the aluminum layer within said openings is resolved by enlarging such openings. It is obvious that this invention also includes liquid crystal display devices with different compositions, using different materials and film thickness for scanning lines and gate insulating layers or different manufacturing methods; this invention is effective not only in the transmissive but also in the reflective and transflective types, and the liquid crystal modes are not limited to the TN type; it is also effective for the liquid crystal mode of vertical-align. Furthermore, it is also verified that the semiconductor layer of the insulating gate type transistors is not under any restrictions.

Other objects, advantages, and novel features of the invention will become more apparent from the following detailed description when taken in conjunction with the accompanying drawings.

### BRIEF DESCRIPTION OF THE DRAWINGS

The objects and advantages of the present invention will be apparent from the following detailed description of the preferred embodiments of the invention with references to the following drawings:

FIG. 1 shows a plan view of an active substrate related to embodiment 1 of this invention.

FIG. 2 shows a manufacture cross section of an active substrate related to embodiment 1 of this invention.

FIG. 3 shows a plan view of an active substrate related to embodiment 2 of this invention.

FIG. 4 shows a manufacture cross section of an active substrate related to embodiment 2 of this invention.

FIG. 5 shows a perspective view showing liquid crystal panel mounting.

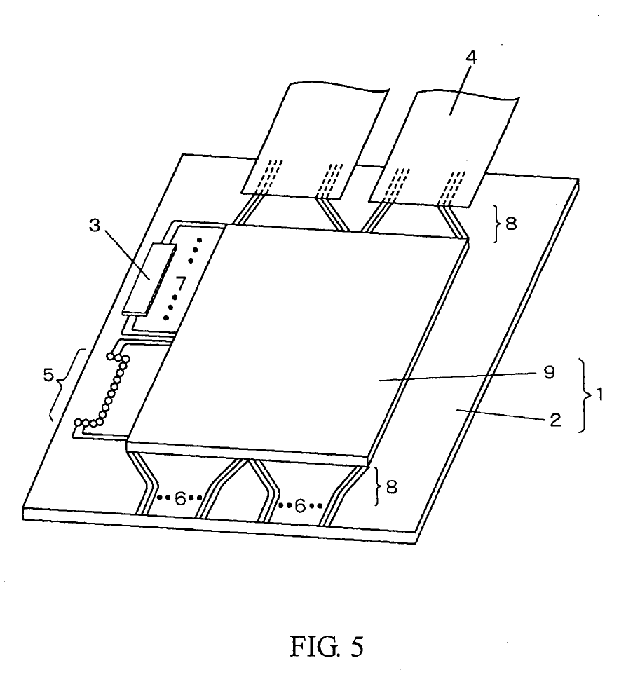

FIG. 6 shows an equivalent circuit of the liquid crystal panel.

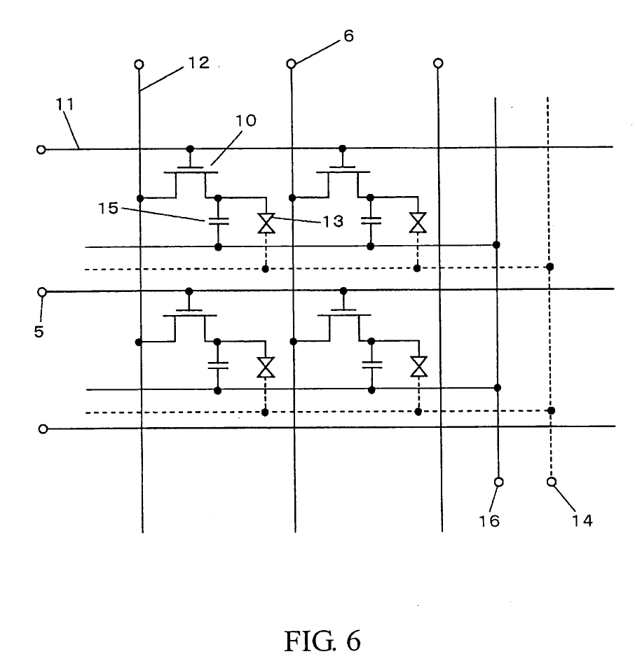

FIG. 7 shows a cross section of the conventional liquid crystal panel.

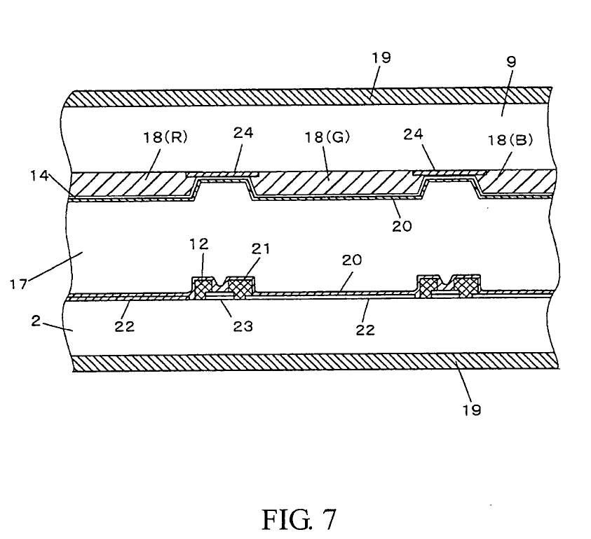

FIG. 8 shows a plan view of an active substrate in conventional embodiment.

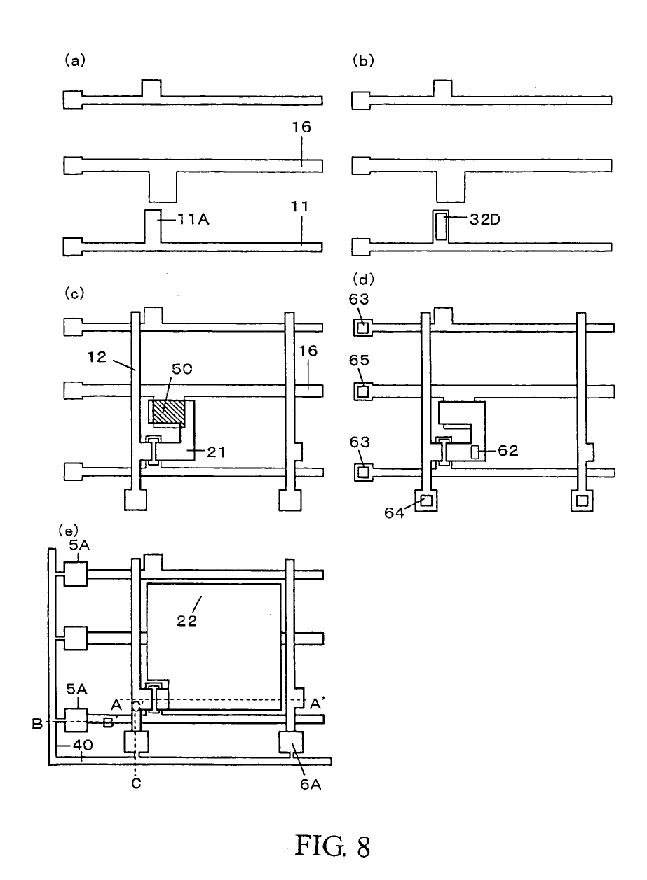

FIG. 9 shows a manufacture cross section of an active substrate in conventional embodiments.

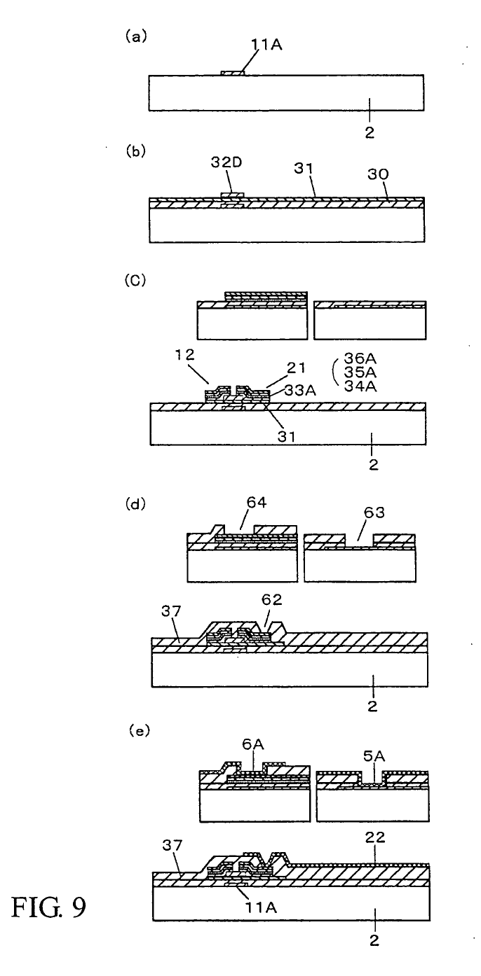

FIG. 10 shows a plan view of a streamlined active substrate.

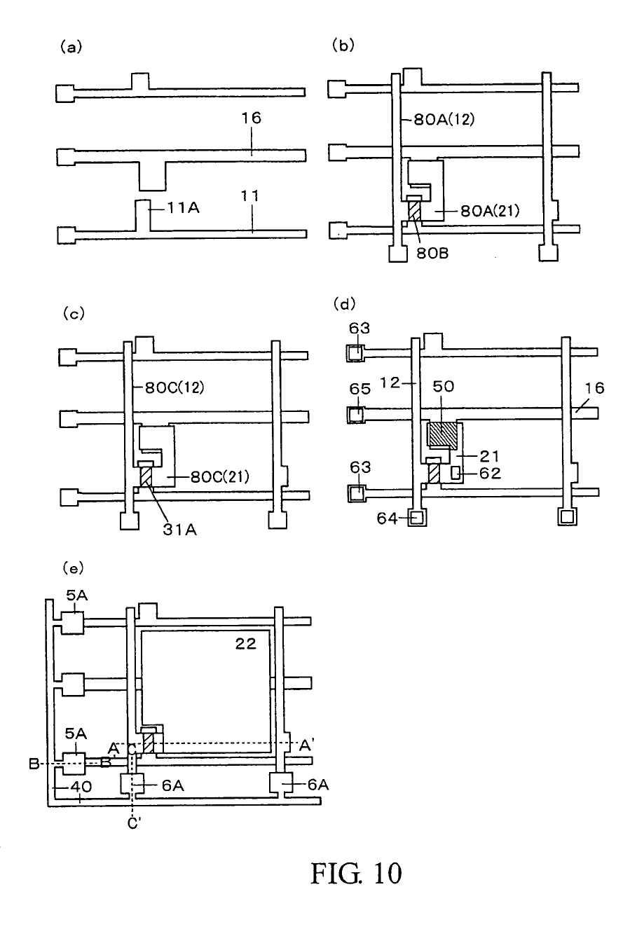

FIG. 11 shows manufacture cross section of a streamlined active substrate.

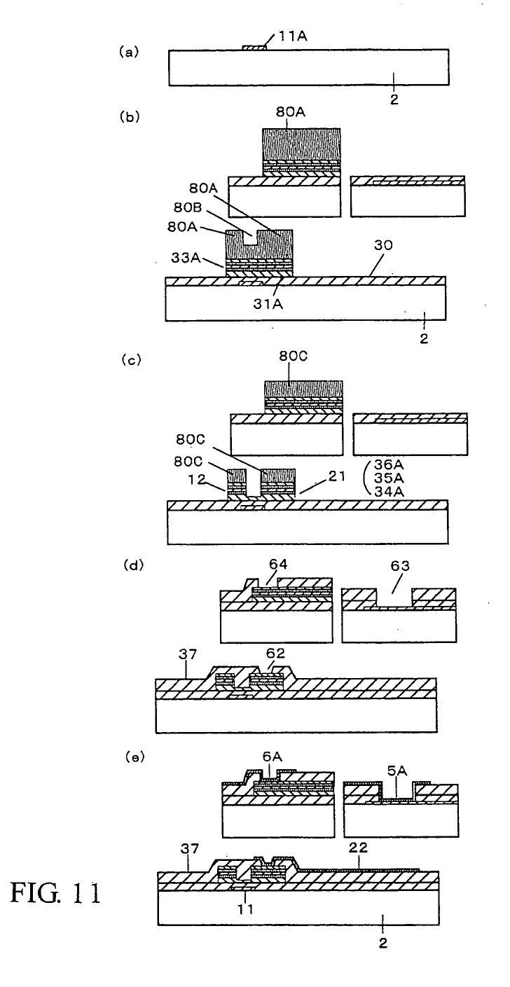

### DETAILED DESCRIPTION OF THE PREFERRED EMBODIMENT

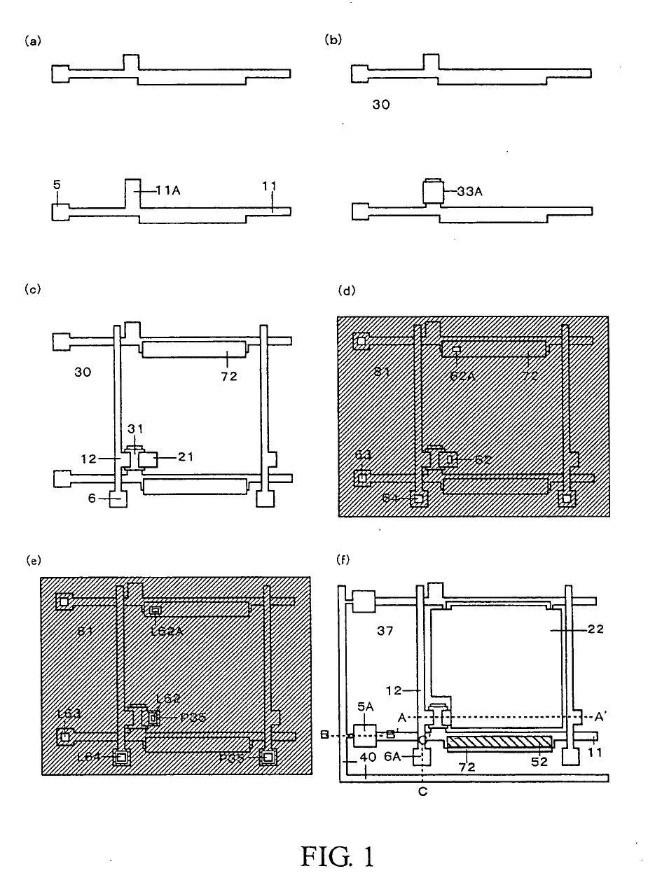

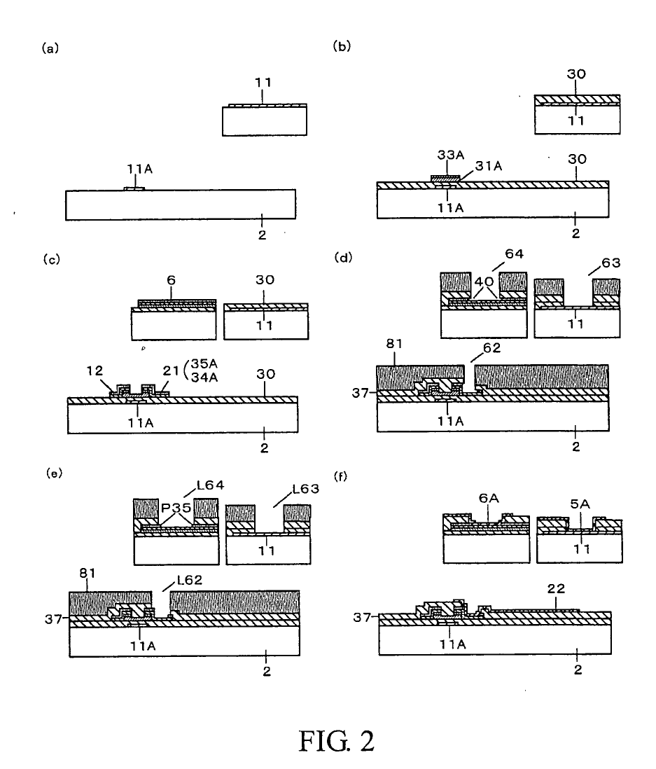

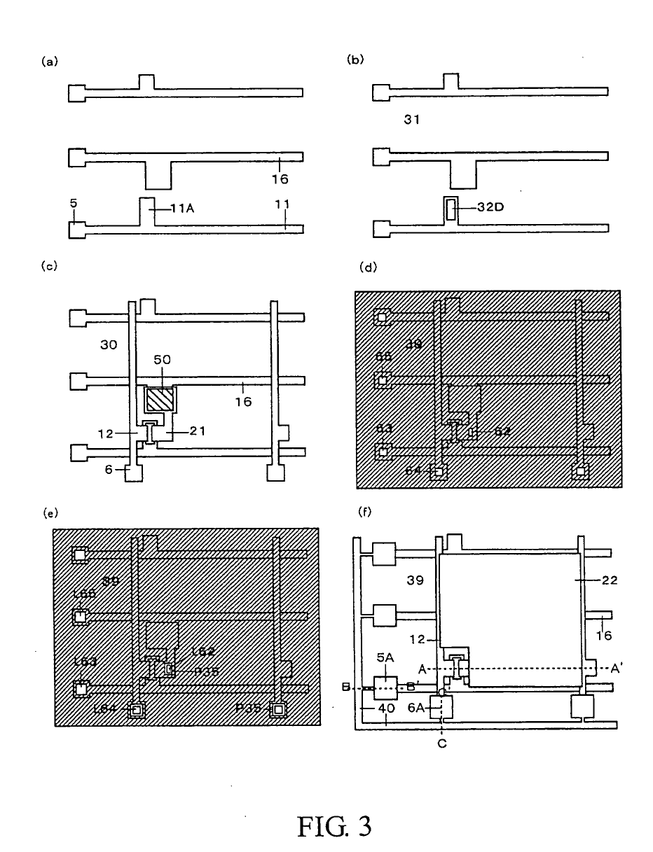

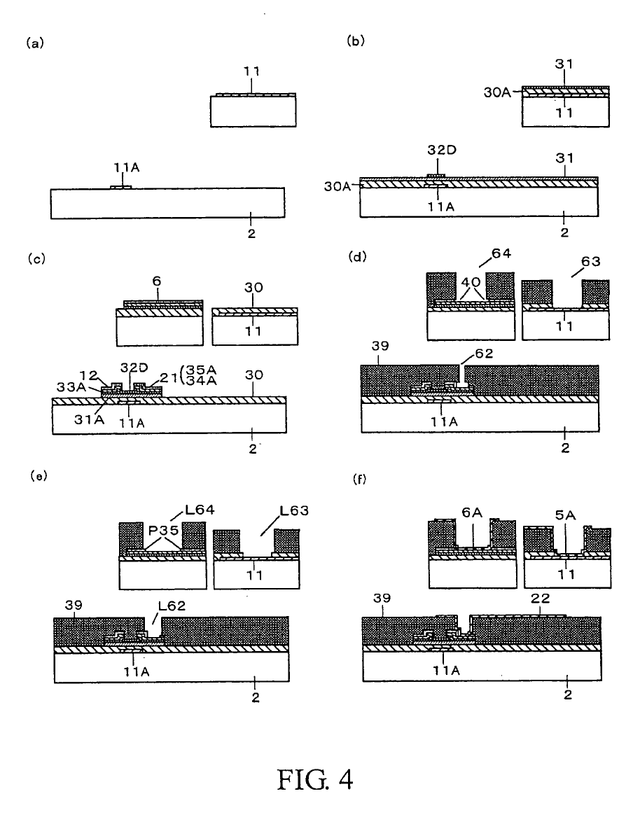

The embodiments of this invention are explained, using FIGS. 1-4. FIG. 1 shows the top view of a semiconductor device for display devices (active substrate) that is related to Embodiment 1, and FIG. 2 shows the cross section of manufacturing processes at A-A′ line, B-B′ line, and C-C′ line of FIG. 1(f). Likewise, Embodiment 2 shows the top view of an active substrate and the cross section of a manufacturing process in FIGS. 3 and 4, respectively. Please note that the part which are the same as the conventional embodiments use the same symbols and do not have detailed descriptions. This invention allows different options for the structure of insulating gate transistors and configurations of storage capacitances, except that the source-drain wires consist of a lamination layer of a heat resistance metal layer and an aluminum layer, and the innovation is in the manufacturing process for forming openings in the passivation insulating layer on drain electrodes. Detailed explanation of Embodiment 1 is given by applying this invention to 5-mask process having channel-etch transistors, but no limitations arise for streamlined 4-mask process having channel-etch transistors.

In Embodiment 1, 1) deposit a heat resistant metal thin film of Cr, Ta, Mo or an alloy of MoW alloys, etc. on the principal plane of a glass substrate 2 as with conventional arts, using a vacuum film-depositing equipment such as an SPT of 0.1-0.2 μm in thickness as the primary metal layer. As shown in FIGS. 1(a) and 2(a), scanning lines 11 that also work as gate electrodes 11A are selectively formed using fine processing technology. Electrode terminals 5 composing part of the scanning lines 11 are formed outside of the image display area at the same time as such scanning lines 11 and gate electrodes 11A are formed.

Next, using a PCVD equipment, 1) successively deposit the following 3 types of thin film layers, for example, at 0.3, 0.2, and 0.05 μm in thickness, respectively: a) an SiNx layer 30 composing a gate insulating layer, b) a primary amorphous silicon layer 31 with hardly any impurities composing the gate transistor channel, and c) a second amorphous silicon layer 33 with impurities composing the source-drains for insulating gate transistors. Next, as shown in FIGS. 1(b) and 2(b), selectively form island-like semiconductor layers consisting of second amorphous silicon layers 33A and primary amorphous silicon layers 31A above the gate electrodes 11A, using fine processing technology, wider than the gate 11 electrodes 11A, exposing the gate insulating layer 30

Now, deposit in the following order: 1) a thin film layer 34 of approximately 0.1 μm in film thickness as a heat-resistant metal layer such as Ti and Ta and 2) an AL thin film layer 35 of approximately 0.3 μm in film thickness as a low resistance wire layer, using a vacuum film-depositing equipment such as the SPT. Next, as shown in FIGS. 1(c) and 2(c), 1) sequentially etch these thin film layers, using fine processing technology as photosensitive resin patterns, and 2) selectively form a) drain electrodes 21 and b) signal lines 12 that also work source wire for insulating gate type transistors, both consisting of the lamination layer of 34A and 35A. However, a secondary amorphous silicon layer 33A and a primary amorphous silicon layer 31A are sequentially etched, and the primary amorphous silicon layer 31A is etched, leaving approximately 0.05-0.1 μm. At the time of the formation of source-drain wires 12 and 21, electrode terminals 6 composing part of the signal lines 12 are also formed outside the image display area.

After forming the source wire 12 and drain wire 21, as with the conventional 5-piece-mask process, 1) deposit, on the entire surface of the glass substrate 2, an SiNx layer of approximately 0.3 μm in thickness as a transparent insulating layer, making it a passivation insulating layer 37, 2) selectively form openings 62, 63, and 64 on drain electrodes 21, part 5 of scanning lines, and part 6 of signal lines, respectively, using fine processing technology such as photosensitive resin patterns 81, and 3) selectively remove the passivation insulating layer 37 and gate insulating layer 30 within the openings 63, exposing these electrodes as shown in FIGS. 1(d) and 2(d). Furthermore, after removing the aluminum layers of the drain electrodes 21 and part of the signal lines 6, which are exposed in openings 62 and 64, using the photosensitive resin pattern 81 as a mask, the aluminum layers are side etched by this removal of the aluminum layer at about 0.3 μm or about the same film thickness of the aluminum layer, and undercuts 40 of the passivation insulating layers 37 are formed at the bottoms of the openings 62 and 64, exposing heat resistant metal layers, which are the lower wires of the source-drain wire materials.

Part 5 of scanning lines are exposed within the openings 63, but aluminum is never used alone as a scanning line material, taking heat-resistance into consideration; a scanning line material is usually consisted of a lamination layer in combination with a heat resistant metal film such as Mo and Cr, exposing these heat resistant metal thin films in the opening 63, thus part 5 of the scanning line is not removed and not disappear when aluminum layers are removed. However, in scanning lines 11 made of an aluminum alloy AL (Ta) or AL (Nd) monolayer including a few % of heat resistant Ta or Nd for example, the aluminum alloys are removed and disappear when the aluminum layers are removed. From this, it should be evident that the scanning lines 11 may be composed of a lamination layer of a heat resistant metal layer and an aluminum alloy as with the source wire 12 and drain wire 21.

It is necessary to resolve undercut 40 as breakings are generated in the pixel electrode 22 when the following pixel electrodes 22 are formed while the undercuts 40 still exist, and one of the means to resolve the problem may be selected to enlarge the openings 62 and 64. For this, the passivation insulating layer 37 in openings 62 and 64, the passivation insulating layer 37 and gate insulating layer 30 in the opening 63 are additionally etched to obtain enlarged openings L62, L63, and L64 as shown in FIGS. 1(e) and 2(e), exposing part of the aluminum layers P35 at the peripheries of the bottoms of said openings L62, L63, and L64. Only the diameter is enlarged for the opening L63. Enlarging the diameter of the opening by 0.5 μm is adequate enough, for it is about twice as much as the value of side etching amount (undercut).

During the additional etching, the additional removal process is shortened if the photosensitive resin pattern 81 is etched at the same time by mixing oxygen gas to fluorine-based gas, which is the etching gas for the passivation insulating layer 37 and gate insulating layer 30. This is due to the enlargement diameter of the openings 62, 63, and 64 that are formed in the photosensitive resin pattern 81 when the film thickness of the photosensitive resin pattern 81 is reduced. The most appropriate mixture ratio may be determined at manufacture sites as it can be largely affected by the quality of target films (process tuning). In Embodiment 1, the passivation insulating layer 37 is only side etched, and the thin film of the passivation insulating layer 37 is not reduced.

After resolving the undercuts 40 in the passivation insulating layer 37, I) Remove the photosensitive resin pattern 81, II) Deposit ITO for example as a transparent conductive layer of about 0.1-0.2 μm in thickness, using a vacuum thin film-depositing equipment such as an SPT on the entire surface of the glass substrate 2, III) Selectively remove the transparent conductive layer using fine processing technology as shown in FIGS. 1(f) and 2(f), and IV) Form pixel electrodes 22, electrode terminals 5A of scanning lines, and electrode terminals 6A of signal lines. For the exposed surface area of the aluminum layer P35 in the openings L62 and L64 is small, no problems such as peelings of the pixel electrodes 22, which are the transparent conductive patterns formed containing the openings L62 and L64 through the reduction using an alkaline developing solution or resist stripping solution. Furthermore, by forming long and narrow stripes in the intervals between electrode terminals 5A/6A and short circuit lines 40 as seen in conventional embodiments, high resistance is obtained as a means for static electricity.

An active substrate 2 thus obtained and a color filter are attached together to form a liquid crystal panel, completing Embodiment 1 of this invention. As for the structure of storage capacitance 15, FIG. 1(f) shows an example (52 or a dotted line descending to the right) of a storage electrode 72, which is formed at the same time as the source-drain wires 12 and 21, and the protruding portion of the scanning line at the upper pixel being overlapped on each flat surface of a gate insulating layer 30. However, the structure of storage capacitance 15 is not limited to this, and an insulating layer including a gate insulating layer 30 may be inserted between the storage capacitance line 16, which is formed at the same time as the scanning line 11, and the drain electrode 21 as seen in conventional embodiments. The electrical connection between the pixel electrode 22 and storage electrode 72 is provided through the opening L62A formed in the passivation insulating layer 37 on the storage electrode 72.

Embodiment 1 uses an inorganic material SiNx layer 37 for the passivation insulating layer as described above, but a similar handling is possible also for liquid crystal display devices so called with a high aperture ratio, in which the surface of the active substrate 2 is made even and flat using a photosensitive acrylic resin of a transparent and heat-resistant organic material for the passivation insulating layer, and the pixel electrodes 22 are formed after forming the thin film of the photosensitive acrylic resin thicker than 3 μms. This is described as Embodiment 2 here. As described before, the structure of insulating gate type transistors and form of the storage capacitance may be selected freely, and Embodiment 2 provides a detailed description, using the etch-stop type 5-mask process.

The manufacturing process of Embodiment 2 is almost the same as that of conventional embodiments up to the following steps in the formation of source-drain wires: I) Sequentially depositing a thin film layer 34 such as Ti and Ta as a heat resistant metal layer and an AL thin film layer 35 as a low resistance wire layer of about 0.3 μm in film thickness, II) Sequentially etching the source-drain wire material consisted of these 2 thin film layers, a second amorphous silicon layer 33, and a first amorphous silicon layer 31, using fine processing technology such as photosensitive resin patterns, exposing a gate insulating layer 30 and protective insulating layers 32D, and III) selectively forming 1) signal lines 12 composing source wires of insulating gate transistors, 2) drain electrodes 21 of insulating gate type transistors, both consisting of a lamination layer of 34A and 35A and partly overlapping with protective insulating layers 32D, and 3) electrode terminals 6 composing part of signal lines 12, as shown in FIGS. 3(c) and 4(c).

After the formation of source-drain wires 12 and 21, I) Form a flat layer 39 by coating photosensitive acrylic resin of high transparency and high heat-resistance, about 3 μms in film thickness, as a transparent insulating layer on the entire surface of a glass substrate 2, II) Form openings 62, 63, and 64 on drain electrodes 21, part 5 of scanning lines, and part 6 of signal lines, respectively, by selectively irradiating ultra violet light and successive developing, exposing part of the drain electrodes 21 and part 6 of the signal lines in openings 62 and 64, respectively as shown in FIGS. 3(d) and 4(d), III) After the development of the said photosensitive acrylic resin, heat-cure the flat layer 39, furthermore, IV) Using the flat layer 39 as a mask, selectively remove the gate insulating layer 30 in the openings 63, exposing part 5 of the scanning lines, and similarly form openings 65 on the storage capacitance lines 16 and exposing part thereof.

Next, when the aluminum layers, which are exposed in openings 62 and 64, are removed using the flat layer 39 as a mask, although it depends on the removal methods of aluminum layers, the aluminum layers are side-etched by about 0.3 μm, which is approximately the same as the film thickness of the aluminum layer, and undercuts 40 of the flat layer 39 are formed at the bottom of the said openings 62 and 64.

It is necessary to resolve undercuts 40 as breakings are generated in the pixel electrodes 22 when the following pixel electrode 22 are formed while the undercuts 40 still exist, and one of the means to resolve the problem may be to enlarge the openings 62 and 64. For this, the thin film of the flat layer 39 is reduced isotropically to obtain enlarged openings L62 L63, L64, and L65 as shown in FIGS. 3(e) and 4(e), exposing part of the aluminum layers 35 at the peripheries of the bottoms of openings L62 and L64. For only the diameter of the openings L63 and L65, formed in the flat layer 39, is enlarged and the gate insulating layer 30 is not etched with oxygen plasmas, descending step-like levels are formed from outside to inside at the cross sections of openings L63 and L65 as same as at openings L62 and L64. Enlarging the diameter of the opening by 0.5 μm is adequate enough, for it is about twice as much as the value of side etching amount (undercut).

After resolving the undercut 40 in the flat layer 39, I) Deposit ITO for example as a transparent conductive layer of about 0.1-0.2 μm in thickness, using a vacuum thin film-depositing equipment such as the SPT on the entire surface of the glass substrate 2, II) Selectively remove the transparent conductive layer using fine processing technology as shown in FIGS. 3(f) and 4(f), and III) Form pixel electrodes 22, electrode terminals 5A of scanning lines, and electrode terminals 6A of signal lines. Although a number is not given, electrode terminals of storage capacitance lines 16 are similarly formed, containing the openings 65.

An active substrate 2 thus obtained and a color filter are attached together to form a liquid crystal panel, completing Embodiment 2 of this invention. As for the structure of storage capacitance 15, FIG. 3(c) shows an example (50 or a dotted line descending to the right), in which a storage capacitance line 16 formed at the same time as the scanning lines 11 are overlapped with a drain electrode 21 on a flat surface. However, the structure of a storage capacitance 15 is not limited to this, and an insulating layer including a gate insulating layer 30 may be inserted between the storage electrode 72 formed at the same time as the source-drain wirings 12 and 21, and said scanning lines 11 as described in Embodiment 1.

As a flat layer 39 consisted of acrylic resin of high transparency is formed on an active substrate 2 in Embodiment 2, additional merits are provided; it not only controls disorientations near drain electrodes 21, which is caused by the step-like levels of the drain electrodes 21, but also the aperture ratio increases by forming pixel electrodes 22 overlaying scanning lines 11 and signal lines 21 as shown in FIG. 3(h). This results from the fact that the electric interferences (parasitic capacitances) caused by the flat overlays of the pixel electrodes 22 with scanning lines 11 and signal lines 21 are mall due to the heavy thickness of the flat layer 39, making it difficult to cause cross talk.

As the etch-stop type insulating gate type transistors have protective insulating layers 32D on channels, forming acrylic resin in the passivation layer of an active substrate 2 does not change the electric properties of the insulating gate type transistors. However it is necessary for channel etch type insulating gate transistors to form a flat layer 39 with acrylic resin after depositing a passivation insulating layer 37 consisted of SiNx on an active substrate 2. Needless to say, removal of the passivation insulating layer 37 in openings 62, 63, 64, and 65 is also required.

In such a case, undercuts 40 of the SiNx layer 37 are formed at the bottom of openings 62 and 64. In order to enlarge the diameter of openings 62 and 64, which are the main subject of this invention, the passivation insulating layer 37 in openings 62 and 64, passivation insulating layer 37 and a gate insulating layer 30 in openings 63 and 65, are additionally etched, using the flat layer 39 again as a mask, to obtain enlarged openings L62, L63, L64, and L65, exposing an aluminum layer P35 at the peripherals of the bottoms of openings L62 and L64. Only the diameter of openings is enlarged for openings L63 and L65, and enlarging the diameter of the opening by 0.5 μm is adequate enough, for it is about twice as much as the value of side etching amount (undercut).

During this additional etching, the additional removal process is shortened if the flat layer 39 is etched at the same time by mixing oxygen gas to fluorine-based gas, which is the etching gas for the passivation insulating layer 37 and gate insulating layer 30. As with Embodiment 1, the most appropriate mixture ratio may be determined at manufacture sites as it can be largely affected by the quality of target films. As the flat layer 39 is not only side-etched but also reduced in film thickness, it is necessary to coat an abundant amount of film, taking the reduced amount into consideration in advance.

Pixel electrodes 22 are not the only part which are formed containing the openings L62, which are formed in the passivation insulating layer on drain electrodes 21, and as described above, transparent conductive electrode terminals 6A for the signal lines are also formed containing the openings L64, which are formed on part 6 of the signal lines 12 outside the image display area, having the same structure. For reflective electrodes composing pixel electrodes are normally formed on a passivation insulating layer containing openings formed on the drain electrodes, in reflective type liquid crystal display devices also, it should be easily understood that the pixel electrodes for this invention do not need to be of transparent conductivity and that metal thin film of conductivity may be used. Thus, in addition to the formations of pixel electrodes and electrode terminals of the signal lines, this invention is also a very effective technology when connection is used as part of multilayer wiring technology between i) wire patterns consisting of a lamination layer of a heat resistant metal layer and an aluminum layer and ii) thin film patterns using thin film for pixel electrode formation.

Realizations in accordance with the present invention therefore have been described in the context of particular embodiments. These embodiments are meant to be illustrative and not limiting. Many variations, modifications, additions, and improvements are possible. For example, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

Although the present invention has been explained in relation to its preferred embodiment, it is to be understood that many other possible modifications and variations can be made without departing from the spirit and scope of the invention as hereinafter claimed.

1. A liquid crystal display device which has at least the following characteristics in a liquid crystal display device that is filled with liquid crystal between 1) a primary transparent insulating substrate that aligns, in a 2-dimensional matrix on a principal plane, unit pixels that have a) an insulating gate type transistor, b) a scanning line that also works as a gate electrode and a signal line that also works as a source wire for the said insulated gate type transistor, and c) a pixel electrode that is connected to a drain wire and 2) a secondary transparent insulating substrate or a color filter that faces the said primary transparent insulating substrate, comprising:
I) scanning lines, insulating gate type transistors, and signal lines consisting of a lamination layer of a heat resistant metal layer and an aluminum layer on a principal plane of a primary transparent insulating substrate;
II) an inorganic passivation insulating layer with openings at least on the drain wires, on the said primary transparent insulating substrate;
III) a conductive layer as pixel electrodes on the inorganic passivation insulating layer in the pixel electrode-forming areas to cover the openings on the said drain wires;
wherein said aluminum layers are slightly exposed at the peripheries of the bottoms of the said openings and the heat resistant metal layers are exposed for the most part.

2. The liquid crystal display device according to claim 1, wherein said heat resistant metal layer is an alloy or a silicide selecting from the group comprising of Cr, Ta, and Mo

3. The liquid crystal display device according to claim 1, wherein said inorganic passivation insulating layer is a silicon nitride (SiNx) layer.

4. The liquid crystal display device according to claim 1, wherein the length of said aluminum layer slightly exposed at the peripheries of the bottoms of the said openings is about twice the thickness of said aluminum layer.

5. A liquid crystal display device which has at least the following characteristics in a liquid crystal display device that is filled with liquid crystal between 1) a primary transparent insulating substrate that aligns, in a 2-dimensional matrix on a principal plane, unit pixels that have a) an insulating gate type transistor, b) a scanning line that also works as a gate electrode and a signal line that also works as a source wire for the said insulated gate type transistor, and c) a pixel electrode that is connected to a drain wire and 2) a secondary transparent insulating substrate or a color filter that faces the said primary transparent insulating substrate, comprising:
I) scanning lines, insulating gate type transistors, and signal lines consisting of a lamination layer of a heat resistant metal layer and an aluminum layer on a principal plane of a primary transparent insulating substrate;
II) a passivation insulating layer with openings at least on the drain wires and having upper layer part comprising a photosensitive organic insulating layer, on the said primary transparent insulating substrate;
III) a conductive layer as pixel electrodes on said organic passivation insulating layer in the pixel electrode-forming areas to contain the openings on the said drain wires;
wherein said aluminum layers are slightly exposed at the peripheries of the bottoms of the said openings and the heat resistant metal layers are exposed for the most part.

6. The liquid crystal display device according to claim 5, wherein said heat resistant metal layer is an alloy or a silicide selecting from the group comprising of Cr, Ta, and Mo.

7. The liquid crystal display device according to claim 5, wherein said photosensitive organic insulating layer is a photosensitive acrylic resin layer.

8. The liquid crystal display device according to claim 5, wherein said passivation insulating layer is a substantially flat layer.

9. The liquid crystal display device according to claim 5, wherein the length of said aluminum layer slightly exposed at the peripheries of the bottoms of the said openings is about twice the thickness of said aluminum layer.

10. A manufacturing method for a liquid crystal display device which has at least the following characteristics in a liquid crystal display device that is filled with liquid crystal between 1) a primary transparent insulating substrate that aligns, in a 2-dimensional matrix on a principal plane, unit pixels that have a) an insulating gate type transistor, b) a scanning line that also works as a gate electrode and a signal line that also works as a source wire for the said insulated gate type transistor, and c) a pixel electrode that is connected to a drain wire and 2) a secondary transparent insulating substrate or a color filter that faces the said primary transparent insulating substrate; for its active substrate comprising the steps of:
forming scanning lines, insulating gate type transistors, and signal lines consisting of a lamination layer of a heat resistant metal layer and an aluminum layer;
forming an inorganic passivation insulating layer with openings at least on the drain wires, on the said primary transparent insulating substrate;
removing the aluminum layers that are exposed in the said openings;
enlarging the said openings; and
forming pixel electrodes to cover said enlarged openings after depositing a conductive layer.

11. The manufacturing method for a liquid crystal display device according to claim 10, wherein said heat resistant metal layer is an alloy or a silicide selecting from the group comprising of Cr, Ta, and Mo.

12. The manufacturing method for a liquid crystal display device according to claim 10, wherein said inorganic passivation insulating layer is a silicon nitride (SiNx) layer.

13. The manufacturing method for a liquid crystal display device according to claim 10, wherein enlarging the said openings is using a dry etch by mixing oxygen gas to fluorine-based gas.

14. The manufacturing method for a liquid crystal display device according to claim 10, wherein the length of enlarging the said openings is about twice the thickness of said aluminum layer.

15. A manufacturing method for a liquid crystal display device which has at least the following characteristics in a liquid crystal display device that is filled with liquid crystal between 1) a primary transparent insulating substrate that aligns, in a 2-dimensional matrix on a principal plane, unit pixels that have a) an insulating gate type transistor, b) a scanning line that also works as a gate electrode and a signal line that also works as a source wire for the said insulated gate type transistor, and c) a pixel electrode that is connected to a drain wire and 2) a secondary transparent insulating substrate or a color filter that faces the said primary transparent insulating substrate; for its active substrate comprising the steps of:
forming scanning lines, insulating gate type transistors, and signal lines consisting of a lamination layer of a heat resistant metal layer and an aluminum layer;
forming a passivation insulating layer which has openings at least on the drain wires and having upper layer part is a photosensitive organic insulating layer, on the said primary transparent insulating substrate;
removing the aluminum layers that are exposed in the said openings;
reducing the film thickness of the said organic passivation insulating layer to enlarge the said openings; and
forming pixel electrodes to cover said enlarged openings, after depositing a conductive layer.

16. The manufacturing method for a liquid crystal display device according to claim 15, wherein said heat resistant metal layer is an alloy or a silicide selecting from the group comprising of Cr, Ta, and Mo.

17. The manufacturing method for a liquid crystal display device according to claim 15, wherein said photosensitive organic insulating layer is a photosensitive acrylic resin layer.

18. The manufacturing method for a liquid crystal display device according to claim 15, wherein said organic passivation insulating layer is a substantially flat layer.

19. The manufacturing method for a liquid crystal display device according to claim 15, wherein reducing the film thickness of the said organic passivation insulating layer is reduced isopropically.

20. The manufacturing method for a liquid crystal display device according to claim 15, wherein the length of enlarging the said openings is about twice the thickness of said aluminum layer.
